(19) United States
(12) Patent Application Publication
(10) Pub. No.: US 2011/0033359 A1
(43) Pub. Date: Feb. 10, 2011

(54) COOLED NAOH FLUE GAS SCRUBBING PRIOR TO CO2 REMOVAL

(75) Inventors: Georg Papenheim, Kerken (DE); Torsten Buddenberg, Moers (DE)

Correspondence Address: OCCHIUTI ROHLICEK & TSAO, LLP, 10 FAWCETT STREET, CAMBRIDGE, MA, 02138, US

(73) Assignee: Hitachi Power Europe GmbH, Duisburg (DE)

(21) Appl. No.: 12/673,627

(22) PCT Filed: Aug. 6, 2008
(86) PCT No.: PCT/EP08/06455

§ 371 Date: Oct. 25, 2010

(30) Foreign Application Priority Data
Aug. 16, 2007 (DE) 10 2007 038 822.7
Sep. 12, 2007 (DE) 10 2007 043 331.1

(51) Int. Cl. B01D 53/56; B01D 53/38

(52) U.S. Cl. 423/235; 423/210; 422/170

(57) ABSTRACT

In a process for removing pollutants from a flue gas stream (31) formed in the firing of a fossil fuel in a combustion chamber of a power station in a plurality of process stages (1, 2, 3), which comprise a first process stage (1) in which the flue gas stream (31, 9, 10) is subjected to gas scrubbing with a first chemical absorbent (6), and a process stage (3) which precedes the first process stage (1), in which the flue gas stream (31) is subjected to a flue gas desulphurization treatment (11) with a calcium-containing chemical absorbent (32), a solution should be provided which makes it possible to reduce the pollutant and solids contents of a flue gas stream formed in the combustion of fossil fuels, in particular coal, to the extent that directly after, with sufficient service life CO₂ separation can be carried out continuously by means of a flue gas scrubber and can be integrated into the exhaust gas purification of a power station, in particular coal power station. This is achieved in that, in the first process stage (1) in at least one first absorber (4, 4a, 36) or flue gas scrubber, a flue gas scrubbing is carried out by means of caustic soda solution or a sodium-hydroxide-containing solution which is fed to the flue gas stream (31, 9, 10) as the first chemical absorbent (6), wherein at least some of the caustic soda solution or sodium-hydroxide-containing solution in this first process stage (1) is returned (13), preferably in circulation, outside the flue gas stream (31, 9, 10) to the site of feeding this chemical absorbent (6) to the flue gas stream (31, 9, 10) and in the course of its return (13), before reaching the site of feeding to the flue gas stream (31, 9, 10) is cooled (16) outside the flue gas stream (31, 9, 10) and/or wherein the flue gas stream (31, 9, 10) is cooled within the first absorber (4, 4a, 36) or flue gas scrubber by means of a cooler or heat exchanger arranged therein.

The invention is directed at a method for the separation of pollutants from a flue gas stream occurring during the firing of a fossil fuel in a combustion chamber of a power station, in a plurality of method stages which comprise a first method stage, in which the flue gas stream is subjected to gas scrubbing with a first chemical absorbent, and a method stage which precedes the first method stage and in which the flue gas stream is subjected to flue gas desulfurization treatment by means of a calcium-containing chemical absorbent.

The invention is directed, furthermore, at a device for the separation of pollutants from a flue gas stream occurring during the firing of a fossil fuel in a combustion chamber of a power station, in a plurality of method stages which comprise a first method stage, which has a first absorber or flue gas scrubber with the supply of a first chemical absorbent, and a method stage which precedes the first method stage and which has a flue gas desulfurization plant with a calcium-containing chemical absorbent.

Finally, the invention is also directed at the use of a device for the separation of pollutants from a flue gas stream occurring during the firing of a fossil fuel in a combustion chamber of a power station, in a plurality of method stages which comprise a first method stage, which has a first absorber or a flue gas scrubber with the supply of a first chemical absorbent, and a method stage which precedes the first method stage and which has a flue gas desulfurization plant with a calcium-containing chemical absorbent, for carrying out a method for the separation of pollutants from the flue gas stream occurring during the firing of the fossil fuel in the combustion chamber of the power station, in a plurality of method stages.

In the debate on the environment, the CO₂ content of flue gases in fossil-fired combustion chambers, in particular of coal-fired power stations, is now the focus of discussion. It is planned to design and construct in future what are known as CO₂-free power stations. One possibility for removing CO₂ from the flue gas is in this case to wash the CO₂ out of the flue gas in corresponding flue gas scrubbing, separate it and then deliver it, if appropriate liquefied, for further use. One possibility of the CO₂ separation is to carry out an amine scrub, in particular with a monoethanolamine solution. So that such an amine scrub can be carried out in practice, under operating conditions, with sufficient service lives and acceptable operating times, and also, as far as possible, continuously, however, the flue gas supplied to the amine scrub has to be largely free of SO₂, SO₃ and dust.

It is therefore specified, in a paper “CO₂-Abtrennung im Kraftwerk” [“CO₂ separation in the power station”] in VGB PowerTech 4/2006, that, for the retrofitting of power stations with an amine scrub, the separation capacity of existing flue gas desulfurization plants would, where appropriate, have to be improved, and this would sometimes necessitate an enlargement of the absorber or the set-up of an additional absorber, including the associated secondary plants.

Furthermore, it is known from practice, in relation to the garbage incineration plant operated by the energy supply company Offenbach AG, to subject the flue gas occurring there to flue gas scrubbing, an SO₂ separation and also a residual separation of HCl, HF and dust being achieved by the injection of dilute caustic soda in countercurrent to the flue gas. In this absorber or flue gas scrubber, the absorbent used is recirculated in a line outside the absorber in closed circuit to the spraying or atomizing device arranged inside the absorber. This flue gas scrub is not provided for carrying out CO₂ separation. Nor is it related to another measure for the CO₂ separation. The NaOH scrub is followed merely by a nitrogen oxide removal plant.

An NaOH flue gas scrub is also implemented in the Hagenholz garbage-fired heating power station of the city of Zurich. There, too, a 30% caustic soda is routed in a closed circuit to ringjet nozzles, by means of which the caustic soda is supplied in countercurrent to the flue gas stream.

A two-stage gas scrub, in which, on the one hand, sea water and, on the other hand, an alkali solution are used as absorbents, is known from DE 21 33 481 A. This citation discloses recirculating a solution sprayed in the gas scrubber, outside the gas scrubber, and supplying it there to a heat exchanger or cooler, so that it is recirculated, cooled, into the flue gas scrubber.

Flue gas desulfurization in which an alkali scrubbing fluid is supplied to a flue gas stream in a flue gas scrubber is also disclosed in EP 0 702 996 A2. Here, the flue gas stream is cooled by means of a heat exchanger arranged inside the flue gas scrubber.

Flue gas desulfurization, in which the flue gas stream is treated with an alkali solution in a flue gas scrubber, sodium hydroxide also being used as an alkali source, is likewise known from EP 0 692 298 A1.

A generic two-stage method for flue gas purification in a power station is disclosed, furthermore, in DE 103 40 349 A1, flue gas purification taking place, in a first stage of a desulfurization/flue gas scrub, by means of a calcium hydroxide or calcium carbonate suspension, and, in a second stage, an amine scrub for CO₂ separation taking place. In the treatment, described here, of the flue gas stream in a fossil-fired power station in a flue gas desulfurization step with subsequent CO₂ scrubbing, in the flue gas desulfurization a scrub is carried out by means of an aqueous calcium hydroxide or calcium carbonate suspension and the CO₂ scrub is carried out by means of an amine scrub.

The object on which the invention is based is to provide a solution which makes it possible to reduce the pollutant and solids content of a flue gas stream occurring during the combustion of fossil fuels, in particular coal, to an extent such that, immediately thereafter, CO₂ separation can be carried out continuously, with a sufficient service life, by means of a flue gas scrub and can be integrated into the exhaust gas purification of a power station, in particular a coal-fired power station.

In a method of the type initially described, this object is achieved, according to the invention, in that, in the first method stage, a flue gas scrub is carried out in at least one first absorber or flue gas scrubber by means of caustic soda or a sodium hydroxide-containing solution supplied as the first chemical absorbent to the flue gas stream, at least part of the caustic soda or sodium hydroxide-containing solution being recirculated, preferably in a closed circuit, in this first method stage, outside the flue gas stream to the location of the supply of this chemical absorbent to the flue gas stream and, in the course of its recirculation, being cooled outside the flue gas stream before it reaches the location of the supply to the flue gas stream and/or the flue gas stream being cooled inside the first absorber or flue gas scrubber by means of a cooler or heat exchanger arranged therein.

The above object is likewise achieved, in a device of the type initially designated, in that, in the first absorber or flue gas scrubber, a spraying or atomizing device is arranged in the flue gas stream and supplies caustic soda or a sodium hydroxide-containing solution as the first absorbent to the flue gas stream, and, outside the first absorber or flue gas scrubber, a line is arranged which is line-connected to the inner space of the first absorber or flue gas scrubber, in such a way that at least part of the first absorbent can thereby be recirculated, preferably in a closed circuit, to the spraying or atomizing device, a cooler or heat exchanger being arranged, upstream of the spraying or atomizing device in the direction of flow of the recirculated first absorbent or of the flue gas stream, in the line and/or in the first absorber or flue gas scrubber in the flue gas stream.

Finally, the above object is also achieved by the use of a device as claimed in one of claims 19 to 25 for carrying out the method as claimed in one of claims 1 to 18.

Advantageous developments and expedient refinements of the invention may be gathered from the respective subclaims.

On account of the two-stage procedure in the device according to the invention and in the method according to the invention, in the first flue gas desulfurization treatment stage based on calcium, the sulfur content of the flue gas stream is already lowered, with customary method parameters being adhered to, to an extent such that, by means of the subsequent following NaOH scrub, dust which remains in it and sulfur oxides or sulfur oxide compounds which remain in it can then easily be eliminated in absorbers or flue gas scrubbers which have a conventional and customary dimension, that is to say do not need to have excessively large dimensioning and therefore do not take up excessive space and installation areas. Furthermore, what is achieved by the NaOH flue gas scrub following the flue gas desulfurization stage and having cooling of the scrubbing fluid and/or of the flue gas stream is that, on the one hand, acid constituents of the gas are absorbed more effectively and to a greater extent, but, on the other hand, the flue gas leaves the NaOH scrub at a relatively low outlet temperature. The result of this low outlet temperature is that, during a CO₂ separation, then following, if appropriate, by means of a further flue gas scrub or scrubbing stage, an improved absorption behavior can be achieved there. In this case, furthermore, the NaOH scrub preceding the CO₂ scrub acts in such a way that the absorption capacity is particularly good on account of the high pH value which can be set by means of the sodium hydroxide. Moreover, the sodium hydroxide forms only soluble compounds with flue gas constituents of the flue gas which are to be separated in this absorber or flue gas scrubber, so that the scrubbing fluid circuit remains essentially free of solids. By the combination according to the invention of a flue gas desulfurization stage based on calcium with a subsequent NaOH scrub, the flue gas is purified to an extent such that, after this NaOH scrub, it is largely free of SO₂, SO₃ and dust and, furthermore, has a temperature which makes it possible subsequently to deliver the flue gas stream directly for CO₂ separation by means of a further gas scrub and, in this further scrubbing stage, to achieve the operating times and service lives sufficient for a continuous operation of a coal-fired large-scale power station. After the two-stage flue gas treatment stages according to the invention, the flue gases have only such a pollution level which makes it possible subsequently to carry out CO₂ scrubs, for example with an amine solution, and at the same time to achieve satisfactory service lives and, in particular, to ensure a continuous operation of the plant with an integrated CO₂ scrub. By means of the two-stage flue gas treatment according to the invention prior to a CO₂ scrub, present if appropriate, not only is the path taken of providing merely an enlargement, in particular doubling, of existing plants, in order to achieve for the CO₂ scrub a flue gas stream having a correspondingly low pollution level, but, in conceptual terms, another path is taken, to be precise the division of the flue gas treatment into two different separate flue gas treatment stages for preparing the flue gas stream for subsequent or integrated CO₂ scrubbing. This affords the possibility of configuring power stations even already designed at the present time so as to be retrofittable for subsequent CO₂ scrubbing or else of retrofitting even already existing power stations with such a CO₂ scrub which, on the one hand, can be implemented, incorporated into the space conditions of the existing plants, and, on the other hand, prepares the flue gas stream to an extent such that it can subsequently be delivered easily for CO₂ scrubbing.

Thus, in the course of the purification of the flue gas stream, an NaOH flue gas scrub (caustic soda or sodium hydroxide-containing solution) is arranged and carried out, in which the first absorbent, caustic soda or sodium hydroxide-containing solution, is cooled, before its reuse in the absorber or flue gas scrubber, by means of a cooler or heat exchanger, and/or in which the flue gas stream is cooled in the first absorber or flue gas scrubber by means of a cooler or heat exchanger, what is achieved is that the flue gas supplied is cooled in the absorber or flue gas scrubber. The result of cooling is that both the flue gas and the recirculating first absorbent are colder at the time point of their reaction with one another, as compared with NaOH scrubbers or scrubs without corresponding cooling. As a result of this, since the chemical absorption behavior of the caustic soda or of the sodium hydroxide-containing solution is higher at low temperature, acid constituents of the gas are absorbed more effectively and to a greater extent by the first absorbent. However, the result of this too, is that the flue gas leaves the first absorber or flue gas scrubber at a lower outlet temperature, as compared with an uncooled NaOH scrub. The outcome of this low outlet temperature is that, during subsequent CO₂ separation by means of a further flue gas scrub or scrubbing stage, an improved absorption behavior can be achieved. Since the flue gas entering the first absorber or flue gas scrubber is, as a rule, 100% saturated with water vapor, water is condensed out. The water will condense on the dust and SO₂ aerosol particles present in the flue gas. These particles are so small that they are separated only with difficulty in a scrubber without condensation. The droplets occurring in the scrubber and provided with taken-up dust and SO₂ aerosol particles as seeds of condensation are separated in the scrubbing fluid descending in the first absorber and collected in the sump of the absorber. By means of the sodium hydroxide used as the first absorbent, a relatively high pH value can be set in the scrubbing solution or in the first absorbent, thus, in turn, entailing an especially high and good absorption capacity, so that a very low SO₂ content is set in the flue gas stream leaving the first absorber or flue gas scrubber. The sodium hydroxide supplied to the first absorbent, whether as caustic soda or as an aqueous sodium hydroxide-containing solution, serves, furthermore, as a neutralizing agent for the acidic gas constituents SO₂ and SO₂ separated in the recirculating first absorbent. Moreover, the sodium hydroxide (NaOH) forms only soluble compounds with the pollutant gases which are separated in this first absorber or flue gas scrubber and which include, in addition to SO₂ and SO₂, HCl and HF, but, in small quantities, also CO₂, so that the scrubbing circuit provided for the solution or fluid consisting of the first absorbent and of reaction products formed in the first absorber or flue gas scrubber remains essentially free of solids, with the exception of the captured dust particles. No caked-on residues on account of temperature changes in the scrubbing fluid can therefore be formed.

Overall, what is achieved by the lower temperature, obtained by cooling, of the flue gas leaving the first absorber and by the use of a sodium hydroxide-containing absorbent is that the flue gas leaving the first absorber or flue gas scrubber is largely free of SO₂, SO₂ and dust and has a temperature which makes it possible subsequently to deliver the flue gas stream directly for CO₂ separation by means of a (further) gas scrub, in particular by means of an amine scrub, and, in this further gas scrubbing stage, to achieve operating times and service lives which are sufficient for continuous operation of, in particular, a coal-fired large-scale power station.

A cooling, to be implemented particularly simply, of the recirculated first chemical absorbent can be achieved in that a cooler or heat exchanger is arranged in the line routed outside the first absorber and the first chemical absorbent is consequently cooled.

The first absorber or flue gas scrubber may be a spray scrubber, a jet scrubber, a Venturi scrubber or a packed tower which, in the multi-stage flue gas treatment, that is to say the flue gas treatment comprising a plurality of method stages, are arranged in a first method stage. In the development, therefore, the invention provides for carrying out the flue gas scrub in the first method stage in one or more spray scrubbers or jet scrubbers or Venturi scrubbers or one or more packed towers.

In this case, within this first method stage, a plurality of first absorbers or flue gas scrubbers may be arranged in parallel, so that, of the previously divided flue gas stream, a first part of the flue gas stream is supplied in parallel to a first spray scrubber or jet scrubber or Venturi scrubber or to a first packed tower and a second part of the flue gas stream is supplied to a third spray scrubber or jet washer or Venturi washer or to a third packed tower. Furthermore, therefore, the invention is distinguished in that the flue gas stream supplied to the first method stage is divided, and, in the first method stage, a first part is supplied to a first spray scrubber or jet scrubber or Venturi scrubber or to a first packed tower and, in the second method stage, a second part is supplied in parallel to a third spray scrubber or jet scrubber or Venturi scrubber or to a third packed tower.

For carrying out flue gas purification in the first method stage or in the first absorber or flue gas scrubber, it is particularly expedient if the recirculated first chemical absorbent is cooled to a temperature of below 40° C., preferably of below or equal to 35° C., in particular to a temperature of approximately 30° C. For the further treatment of the flue gas stream leaving the first method stage, it is expedient and advantageous if, in the first method stage, the flue gas stream is cooled to a temperature of below or equal to 50° C., in particular of below or equal to 45° C., preferably to a temperature of approximately 40° C.

In an especially advantageous development, according to the invention, in a second method stage following the first method stage, the flue gas stream or the first and the second part of the flue gas stream is or are subjected to treatment with a second chemical absorbent different from that of the first method stage, in particular to an amine scrub, preferably a scrub with an alkanolamine solution, preferably monoethanolamine (MEA) solution, or to a potash scrub with a potassium carbonate solution or to an ammonia scrub with an aqueous ammonia solution and/or with a solution containing at least two of the above solutions in mixture. For carrying out CO₂ separation in this subsequent second method stage, the flue gas stream is prepared as a result of the treatment, preceding according to the invention, in the first method stage, in particular has its pollutant and solids content reduced, to an extent such that it can be supplied directly to this second method stage and this can then also be carried out continuously with service lives and operating times necessary for operating a large-scale power station.

A second chemical absorbent to be used especially advantageously in the second method stage expediently contains piperazine. Furthermore, if desired, the second chemical absorbent used in the second method stage may also be delivered for regeneration treatment and be supplied to the flue gas stream in a closed circuit. According to the invention, therefore, a regenerative second chemical absorbent is furthermore used, and this, after running through regeneration treatment in the second method stage, is recirculated into the flue gas stream or the first part and second part of the flue gas stream and is cooled before being supplied to the flue gas stream.

The second method stage, too, is advantageously carried out, using known types of scrubber. The invention therefore provides, furthermore, for carrying out the flue gas scrub in the second method stage in one or more spray scrubbers or jet scrubbers or Venturi scrubbers or in one or more packed towers.

Furthermore, it is also possible in the second method stage to divide the flue gas stream into parallel branches. In a development, therefore, the invention is distinguished, furthermore, in that the flue gas stream or flue gas part stream supplied to the second method stage is divided, and, in the second method stage, a third part is supplied to a second spray scrubber or jet scrubber or Venturi scrubber or to a second packed tower and, in the second method stage, a fourth part is supplied in parallel to a fourth spray scrubber or jet scrubber or Venturi scrubber or to a fourth packed tower.

In a further advantageous development and refinement of the invention, in the method stage preceding the first method stage the flue gas stream is subjected to a flue gas scrub by means of the calcium-containing chemical absorbent, gypsum thereby being formed. Since the first method stage is preceded by the preceding method stage in which the flue gas stream is subjected to flue gas desulfurization treatment, the sulfur content, that is to say, in particular, the SO₂ and SO₂ content, of the flue gas stream is lowered before it enters the first absorber or flue gas scrubber of the first method stage, to an extent such that, in this first method stage, the fullest possible elimination, necessary for the further treatment of the flue gas in the second method stage, of dust, SO₂ and SO₂ can be carried out easily and in plants which have a conventional and customary dimension, that is to say do not need to have excessively large dimensioning and therefore do not take up excessive space and installation area. It is in this case especially expedient to use a calcium-containing chemical absorbent to be converted into gypsum.

In this case, in an expedient refinement of the invention, there may be provision whereby part of the first chemical absorbent used in the first method stage is admixed to the (third) chemical absorbent in the preceding method stage. In this case, the first chemical absorbent may also contain reaction products occurring in the first absorber or flue gas scrubber. For example, the flue gas desulfurization treatment in the preceding method stage may be conventional desulfurization based on limestone or calcium, with gypsum being obtained. As a result of this measure, part of the scrubbing fluid occurring in the first method stage in the first absorber or flue gas scrubber is transferred to the (chemical) absorber or flue gas scrubber of the preceding method stage and therefore at least part of the sodium sulfate which has occurred in the first method stage, of the dust-laden condensed water and of the further reaction products is discharged into the (third) absorber of the preceding method stage. What occurs then in the absorber or flue gas scrubber of the preceding method stage, insofar as this is operating on a calcium basis, is a conversion/precipitation reaction of the sodium sulfate supplied with the calcium chloride, which is formed there, into gypsum and sodium chloride. The increased or additional content of sodium, set in the absorber or flue gas scrubber of the preceding method stage as a result of the supply of the first absorbent to this, in the scrubbing fluid located there leads, in this preceding method stage, to an improved degree of separation of the flue gas pollutants in the (third) chemical absorbent used in this method stage.

Furthermore, in a refinement, the invention provides for supplying a water vapor-saturated flue gas stream to the flue gas scrub of the first method stage.

For achieving an advantageously low pollution level of the flue gas stream, furthermore, according to a development of the invention, it is advantageous if the flue gas stream leaving the preceding method stage is supplied, preferably being divided into the first and second part of the flue gas stream, directly to the first method stage.

It is expedient, furthermore, also to have the division to the effect that the flue gas stream leaving the first method stage is supplied, preferably being divided into the third or fourth part of the flue gas stream, directly to the second method stage, as is likewise provided by the invention.

Moreover, a dust-filtering treatment or the arrangement of a dust filter at least upstream of a flue gas treatment taking place in the first method stage or the second method stage or the preceding method stage is advantageous. The invention therefore provides, furthermore, for all or part of the divided flue gas stream to be subjected in each case to a dust-filtering treatment preceding at least the first or second or preceding method stage, preferably by means of an electrostatic filter.

It is likewise expedient and advantageous if a nitrogen oxide removal treatment or nitrogen oxide removal device preceding or following at least the first or the second or the preceding method stage is provided. The invention is therefore distinguished, furthermore, in that all or part of the divided flue gas stream is or are subjected in each case to a nitrogen oxide removal treatment preceding or following at least the first or second or preceding method stage, preferably by means of an, in particular catalytic, selective method.

In particular, the invention makes it possible that the flue gas treatment with all three method stages is carried out continuously and simultaneously and in this case a flue gas stream is treated successively first in the preceding, then in the first and finally in the second method stage. Such a flue gas treatment plant comprising the first, second and preceding method stage is expediently an integral part of the flue gas treatment to which a flue gas stream occurring in a coal-fired large-scale power station with steam generator is subjected. The invention therefore also provides for carrying out the method continuously, in particular with the simultaneous operation of the first, second and preceding method stage.

By means of the refinements and developments according to the invention of the device, according to the dependent subclaims, the same advantages can be achieved as are specified above with regard to the method claims corresponding in each case.

The same applies to the use claim.

It would be appreciated that the features mentioned above and those yet to be explained below can be used not only in the combination specified in each case, but also in other combinations. The scope of the invention is defined only by the claims.

The invention is explained in more detail below, by way of example, with reference to a drawing in which:

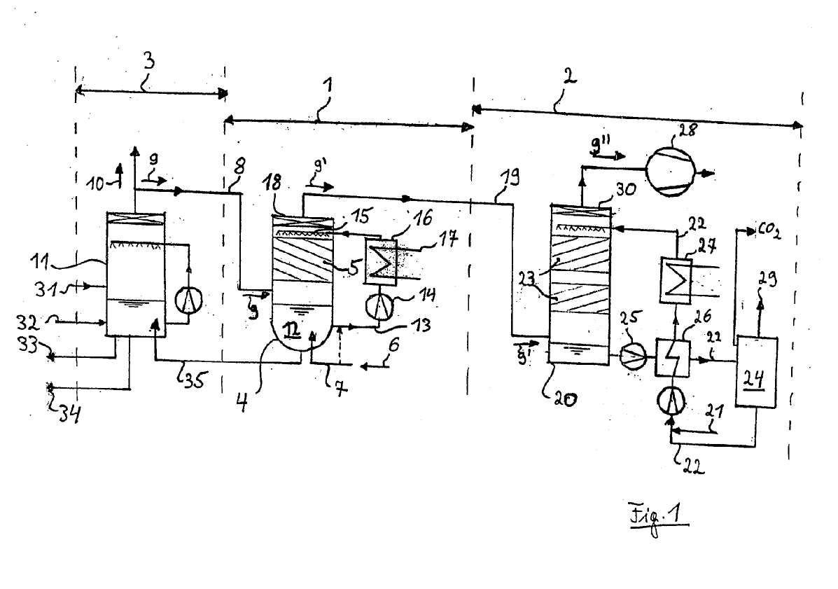

FIG. 1 shows, in a diagrammatic illustration, a first exemplary embodiment of a device according to the invention for carrying out the method according to the invention,

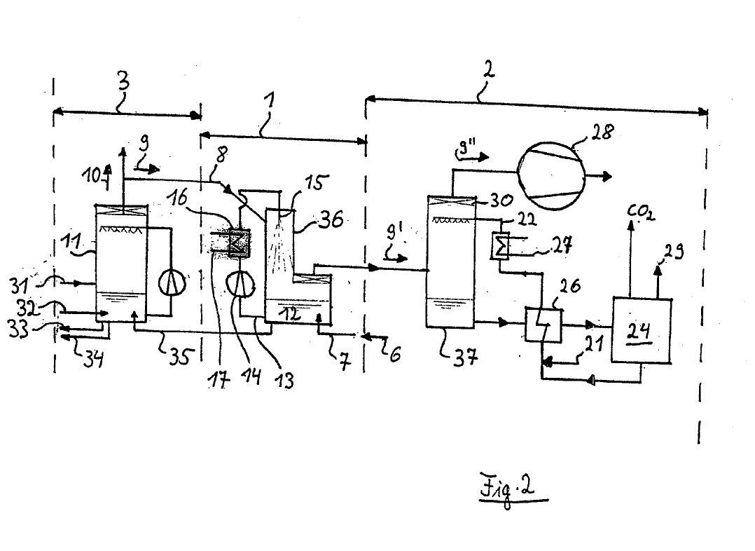

FIG. 2 shows, in a diagrammatic illustration, a second exemplary embodiment of a device according to the invention for carrying out the method according to the invention, and

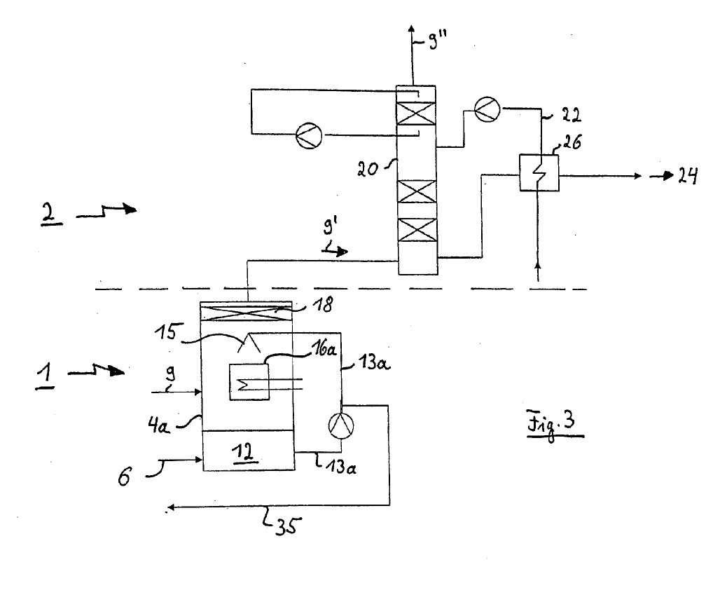

FIG. 3 shows, in a diagrammatic illustration, a third exemplary embodiment of a device according to the invention for carrying out the method according to the invention.

FIGS. 1 to 3 show part regions of a flue gas treatment plant which comprises devices for the separation of pollutants from the flue gas and which consists in FIGS. 1 and 2 of a first method stage 1, of a second method stage 2 and of a preceding method stage 3 and, in the illustration according to FIG. 3, of a first method stage 1 and of a second method stage 2.

In the embodiment according to FIG. 1, the first method stage 1 comprises a first flue gas scrubber 4 which is designed as a packed tower. That region of the packed bed 5 which is provided with packing is illustrated as a hatched region. Caustic soda or a sodium hydroxide-containing solution is supplied via a line 7 as a first chemical absorbent 6 to the first flue gas scrubber 4. However, part may also be supplied to a closed circuit line 13, as indicated by the dashed line. Likewise, a flue gas stream, in the present case a first part 9 of a flue gas stream 31, is supplied to the first flue gas scrubber 4 via a line 8. This first part 9 has occurred due to the division of a flue gas stream 31 leaving a flue gas desulfurization plant 11 into this first part 9 of the flue gas stream 31 and a second part 10 of the flue gas stream 31. The caustic soda or sodium hydroxide-containing solution supplied as the first chemical absorbent 6 to the first flue gas scrubber 4 is supplied from the sump 12 or, depending on the embodiment, if appropriate, also from a quench region, via a line 13 having a pump 14 arranged in it, to spraying or atomizing nozzles 15 arranged above the packed bed 5. A cooler or heat exchanger 16 is arranged in the line 13 upstream of the spraying or atomizing nozzles 15 in the direction of flow of the first chemical absorbent 6. A cooling medium is supplied via a line 17 to the cooler or heat exchanger 16 and is routed away from this again. A drop separator 18 is arranged above the spraying or atomizing nozzles 15 in the first flue gas scrubber 4. In the first flue gas scrubber 4, the supplied first part 9 of the flue gas stream is routed to the spraying or atomizing nozzles 15, through the packed bed 5, in countercurrent to the first chemical absorbent 6 (caustic soda or sodium hydroxide-containing solution) introduced into the first flue gas scrubber 4 by the spraying or atomizing nozzles 15 and is subjected to the conventional mechanisms of flue gas scrubbing. After flowing through the drop separator 18, the first part 9 of the flue gas stream then leaves the first flue gas scrubber 4. As a result of being freed in the first flue gas scrubber 4 of SO₂, SO₃, further acidic gas constituents and dust, a first flue gas part stream then emerges from the first flue gas scrubber 4 and is supplied to the second method stage 2 as a flue gas part stream 9′ purified in the first method stage 1. So that the purified first flue gas part stream 9′ leaving the first flue gas scrubber 4 is sufficiently free of pollutants and of solids, the flue gas entering the first flue gas scrubber 4 is cooled down to an extent such that the flue gas stream has a temperature of below 50° C., in particular a temperature of approximately 40° C. This is achieved in that, by means of the cooler or heat exchanger 16, the first chemical absorbent 6 supplied to the spraying or atomizing nozzles 15 is cooled to a temperature, to be precise a temperature of below 40° C., in particular of approximately 30° C., such that the flue gas 9′ leaving the first flue gas scrubber 4 has the desired temperature. The first chemical absorbent 6 supplied to the inner space of the first flue gas scrubber 4 via the spray nozzles 15 collects, together with the reaction products formed in the first flue gas scrubber 4 and with the dust particles adhering to the sprayed water drops formed as the result of condensation, in the sump 12 of the first flue gas scrubber 4. The first chemical absorbent 6 is routed from there in closed circuit via the line 13, so that sufficiently cooled first chemical absorbent 6 is regularly made available for the flue gas scrubbing in the first flue gas scrubber 4. With the exception of the cooler or heat exchanger 16, the first flue gas scrubber 4 corresponds to a conventional flue gas scrubber designed as a packed tower. Instead of this type, however, other types of flue gas scrubber, such as spray scrubbers or jet scrubbers or Venturi scrubbers, may also be used in the first method stage 1. It is important merely that a cooling of the first chemical absorbent 6 supplied and, if appropriate, recirculated is provided.

As is clear from the embodiment according to FIG. 3, however, instead of the cooler 16 arranged in the line 13 a cooler 16a may also be arranged inside a first flue gas scrubber 4a, so that, here, a cooling of the flue gas stream 9 does not take place directly by the first chemical absorbent 6 supplied or recirculated, but, instead, by means of the cooler or heat exchanger 16a arranged inside the first flue gas scrubber 4a. A combination of an internally arranged cooler or heat exchanger 16a and of a cooler 16 arranged in a supply line 13, 13a is, of course, also possible.

After running through the first method stage 1, the pollutants and dust occurring during the combustion of fossil fuels, in particular during the combustion of coal, are separated from the first flue gas part stream 9′ and reduced to an extent such that this can then be supplied immediately and directly for treatment of the CO₂ separation and removal in the second method stage 2. The line 19 carrying the first flue gas part stream 9′ therefore issues into a second flue gas scrubber 20, in which the flue gas part stream 9′ is treated, that is to say is scrubbed, by means of a second chemical absorbent 21. In the second absorber or flue gas scrubber 20, the first flue gas part stream 9′ is subjected to an amine scrub. It is also possible, however, to carry out at this point a potash scrub with a calcium carbonate solution or an ammonia scrub with an aqueous ammonia solution. In the second method stage, a monoethanolamine (MEA) solution is supplied as a second chemical absorbent 21 to a supply line 22. Instead of the monoethanolamine or in mixture with this, however, methyldiethanolamine (MDEA), diethanolamine, diisopropylamine and/or diglycolamine may also be used as the second chemical absorbent 21. As is known from conventional amine scrubs, in the second absorber or flue gas scrubber 20 the second chemical absorbent 21 is injected above packed beds 23 in countercurrent to the third flue gas part stream 9′ and is routed in closed circuit, with a regeneration stage 24 being interposed. A pump 25, a heat exchanger 26 and a cooler 27 are usually arranged in the closed circuit line 22. The flue gas stream 9″ leaving the second absorber or flue gas scrubber 20 is CO₂-free after running through the second flue gas scrubber 20 and can be discharged into the atmosphere as CO₂-free exhaust gas with the aid of a flue 28. The CO₂ is delivered for further use, whether for storage or further processing, with the aid of the regeneration device 24. Moreover, only exhaust air 29 emerges from the regeneration device 24. The amine scrub carried out in the second method stage 2 in the second absorber or flue gas scrubber 20 having a drop separator 30 is a conventional amine scrub. However, so that this can be used with sufficient operating times and service lives as an integral part of flue gas treatment for the flue gas occurring particularly in fossil-fired, especially coal-fired large-scale power stations, the flue gas supplied to this second method stage has, according to the invention, been freed as fully as possible, in the first method stage 1, of the pollutants and solids detrimental to the flue gas scrub in the second method stage 2. For this purpose, according to the invention, a flue gas scrub with caustic soda or sodium hydroxide-containing solution as the first chemical absorbent 6 is employed, and at the same time, in this stage 1, a cooling of the flue gas stream 31, 9, 10 routed through this first method stage 1 takes place. This is achieved by installing a cooler 16a or heat exchanger in the first absorber 4, 4a, 36 or first flue gas scrubber, which comes into direct contact with the flue gas stream, or by cooling (cooler 16) the first chemical absorbent 6 which comes into contact with the flue gas stream.

Furthermore, the embodiment according to FIG. 1 provides for a preceding (third) method stage 3 which precedes the first method stage 1 and in which the flue gas desulfurization plant 11 with a third (chemical) absorber or flue gas scrubber is arranged. The flue gas coming from the combustion chamber of a fossil-fired, in particular coal-fired power station is delivered as a flue gas stream 31 to this flue gas desulfurization plant 11. In the flue gas desulfurization plant 11, as is customary in plants of this type, a calcium-containing, for example CaCO₃-containing solution is routed in a closed circuit and sprayed as a third chemical absorbent 32. Waste water 33 and gypsum 34 are drawn off from the flue gas desulfurization plant 11. The first flue gas scrubber 4 is connected via a line 35 to the flue gas desulfurization plant 11 so that, from the sump 12 of the first flue gas scrubber 4, part of the first chemical absorbent 6 or of the mixture formed in the sump 12 from the first chemical absorbent 6 and the reaction products is supplied to the flue gas desulfurization plant 11 and admixed to the third chemical absorbent 32 there.

The flue gas stream leaving the flue gas desulfurization plant 11 is thereafter divided into the first flue gas part stream 9 and the second flue gas stream 10. In a way not illustrated, the second flue gas stream 10 then likewise flows, in parallel to the first flue gas part stream 9, through a first method stage 1 with a further first absorber or flue gas scrubber, which is arranged parallel to the first absorber or flue gas scrubber 4 and the flue gas exhaust stream of which is then supplied, for example as a third or fourth flue gas part stream, either to the second absorber or flue gas scrubber 20 in the second method stage 2 or to a further second flue gas scrubber arranged parallel thereto. Depending on the quantity and occurrence of the flue gas, however, it is also possible to dispense with the division into the first part stream 9 and second part stream 10 and to supply the entire flue gas 31 emerging from the flue gas desulfurization plant 11 to the first flue gas scrubber 4 of the first method stage 1 and to the second flue gas scrubber 20 of the second method stage 2 and free it there as fully as possible of pollutants, in the second method stage of CO₂.

With the aid of the flue gas scrub provided in the first method stage 1, with a cooling of the flue gas stream to a temperature of below or equal to 50° C., in particular of approximately 40° C., a “CO₂ Capture Ready” power station, as it is known, can also be conceived, that is to say a power station is provided, having a flue gas treatment which prepares the flue gas to an extent such that, if desired, it can be followed immediately thereafter, without further measures, by a flue gas treatment stage, by means of which CO₂ can also be removed from the flue gas.

The embodiment according to FIG. 2 differs from the embodiment according to FIG. 1 merely in that the first absorber or flue gas scrubber used is a jet scrubber 36 in which, as is conventional in jet scrubbers, the flue gas stream 9 and the injected first chemical absorbent 6 are routed in countercurrent. The further difference is that the second absorber or flue gas scrubber of the second method stage 2 is designed as a spray scrubber or spray tower scrubber 37, no longer as a scrubbing column or packed tower 20. Since the further device elements are otherwise identical to the embodiment according to FIG. 1, these are also given the same reference symbols in FIG. 2.

The embodiment according to FIG. 3 differs from the embodiments according to FIGS. 1 and 2 in that only the first method stage 1 and the second method stage 2 are illustrated there. The preceding (third) method stage 3 is not illustrated. While the second method stage 2 is designed as an amine scrub, as in the embodiment according to FIG. 1, the first absorber or flue gas scrubber 4a differs from that of FIGS. 1 and 2 essentially only in that, there, a cooler or heat exchanger 16a is arranged inside the absorber or flue gas scrubber 4a and therefore cools the flue gas stream 9 flowing in the first flue gas scrubber or absorber 4a. Furthermore, the line 35 leading to the flue gas desulfurization plant 11 of the preceding (third) method stage, not illustrated, is designed as a branch-off from the line 13a routing the first absorbent 6 in a closed circuit.

In a way not illustrated, the device or plant according to the invention for the treatment of a flue gas stream may be equipped with a dust filter, for example a wet electrostatic filter, and with a nitrogen oxide removal device, in particular a catalytically and selectively acting nitrogen oxide removal device. Preferably, the dust filter is located upstream of the preceding (third) method stage 3 in the direction of flow of the flue gas stream, and the nitrogen oxide removal plant is located downstream of the second method stage 2 in the direction of flow of the flue gas stream. Basically, however, it is possible that the dust-filtering treatment, that is to say the dust filter, is arranged upstream of one of the method stages 1 to 3 and the nitrogen oxide removal treatment, that is to say the nitrogen oxide removal device, is arranged upstream or downstream of one of the method stages 1 to 3.

By means of the first method stage 1 and the preceding flue gas desulfurization plant 11 and assigned dust filters and nitrogen oxide removal plants, the flue gas stream 31 occurring in the combustion chamber of a fossil-fired, in particular coal-fired large-scale power station can be treated in a continuous type of operation for the generation of steam and can be supplied for treatment for the separation of pollutants and solids, in particular dust. Likewise, this can then be followed directly in a continuous type of operation by a CO₂ separation, since, in the first method stage 1, the flue gas is prepared and purified as fully as possible of pollutants and dust, to an extent that, in particular, the service lives and actions of an amine scrub are consequently no longer adversely affected. In addition to the constituents SO₂ and SO₃, in the first method stage 1 HCl, HF, partially CO₂ and also dust and mercury are also separated by means of the scrubbing fluid or the first chemical absorbent 6 or the scrubbing fluid routed in closed circuit.

The first method stage 1 and, if appropriate, the second method stage 2 and the preceding (third) method stage 3 and also the further devices and plants having, if desired, a dust filter and a nitrogen oxide removal plant are suitable for the treatment of any exhaust gases occurring during combustion, that is to say can follow power stations, metallurgical works or fertilizer production plants or be integrated into these.

The flue gas leaving the first method stage 1 has, in particular, a pressure of approximately 1 bar, a temperature of lower than or equal to 50° C., an SO₂ content of lower than 10 ppm and a dust level of lower than or equal to 10 mg/m³.

An exemplary method sequence looks as follows:

A flue gas stream 31 of approximately 1 800 000 m³/h [N.tr. (dry standard conditions)] is delivered from an 800 MW coal-fired boiler with a temperature of 120° C. and with an SOₓ content of 3600 mg/m³ [N.tr. (dry standard conditions)], an HF content of 13 mg/m³ [N.tr. (dry standard conditions)] and a dust content of 20 mg/m³ [N.tr. (dry standard conditions)] and a composition of CO₂ 14%, H₂O 8.5%, O₂ 4%, Ar 0.9% and the rest N₂ to a limestone scrubbing process in a flue gas desulfurization plant 11. Here, SO₂, SO₃, HCl, HF and dust are separated. The flue gas stream 9, 10 thereafter has a temperature of approximately 50° C. and contents of SOₓ (SO₂ and SO₃) of approximately 100 mg/m³ [N.tr. (dry standard conditions)], of HCl of <5 mg/m³ [N.tr. (dry standard conditions)], of HF of <1 mg/m³ [N.tr. (dry standard conditions)] and of dust of <10 mg/m³ [N.tr. (dry standard conditions)]. In the flue gas desulfurization plant 11, approximately 40 000 m³ of scrubbing fluid (density approximately 1.15 kg/m³, CaO₃ approximately 2.3% of the solids, consumption: CaO₃/S=approximately 1.03) are circulated per hour in an open spray absorber. Approximately 90 m³/h are locked out from this suspension for gypsum dewatering 34 of which approximately 10 m³ are locked out as waste water 33. Water evaporates in absorbers 11, so that, in total, a process water consumption of 90 m³/h is obtained. This is topped up partially by fresh process water and is partially satisfied from plants located downstream of the outflow. Such a spray absorber 11 has a diameter of approximately 15 m and a sump volume of approximately 3500 m³.

After this preceding (third) method stage 3, the flue gas stream 9, 10 is supplied, in a first method stage 1, for NaOH scrubbing in the first absorber or flue gas scrubber 4, 4a, 36 which may be designed as a packed tower or packed towers, spray scrubber, jet scrubber or Venturi scrubber, its circulating solution (first chemical absorbent 6) being cooled to approximately 30° C.

The circulation quantity of the first chemical absorbent 6 amounts to a total of approximately 6000 m³/h. A cooling water stream of approximately 1300 m³/h at a forward flow temperature of 25° C. is required. The NaOH consumption amounts to approximately 230 kg. In this first absorber or flue gas scrubber 4, 4a, 36, the pollutant content is further reduced. The emerging flue gas stream 9′ has a temperature of approximately 40° C. and a content of SOₓ of <5 mg/m³ [N.tr. (dry standard conditions)], of HCl of <<1 mg/m³ [N.tr. (dry standard conditions)], of HF of <<1 mg/m³ and of dust of <1 mg/m³ [N.tr. (dry standard conditions)]. The outflow 35 from this process of approximately 70 m³/h is delivered to the flue gas desulfurization plant 11. When packed towers are used as the first absorber or flue gas scrubber 4, 4a, 36, in the present example the process is subdivided into two strands 9, 10 routed in parallel, so that two packed towers with a diameter of approximately 14 m are present which are operated in each case in countercurrent.

After this first method stage 1, in a second method stage 2, the flue gas streams are likewise delivered in two strands routed in parallel, for CO₂ separation, to two second absorbers or flue gas scrubbers 20 with a diameter of 14 m which are operated in countercurrent as packed towers (instead of packed towers, other reactor types may also be used, for example jet scrubbers, Venturi scrubbers or spray tower absorbers). These are operated with an aqueous monoethanolamine solution 21 of approximately 28% by weight of MEA (approximately 7 mol MEA per liter of solution) as the second chemical absorbent. Other substances, such as piperazine, may also be admixed to this solution for activation, or a piperazine-activated K₂CO₃ solution in a molar ratio of 1 to 2 is used (for example, 5 mol/l of K₂CO₃ and 2.5 mol/l of piperazine in water). In order in this method stage 2 to achieve a separation of approximately 90% of the CO₂ contained in the flue gas, an overall circulation quantity of approximately 6700 m³/h of MEA solution is required if a load difference of the absorbent of approximately 50% is presupposed, which is set in the associated regeneration device 24.

In the second method stage 2, different strategies may be adopted for minimizing the energy consumption. The regenerated MEA solution stream 22 may additionally be cooled 22, 27, in order to increase the possible load level of the solution. The circulation stream is routed continuously via a heat exchanger 26 for regeneration and recirculation. The CO₂ obtained during regeneration is compressed and liquefied (approximately 494 t/h) and may be delivered for dumping or other purposes.

Thus, a pure gas 9″ of approximately 1 575 000 mg/m³ [N.tr. (dry standard conditions)] is obtained downstream of an 800 MW coal-fired boiler, said gas having a temperature of <50° C. and contents of SOₓ of <<5 mg/m³ [N.tr. (dry standard conditions)], of HCl of <<1 mg/m³ [N.tr. (dry standard conditions)], of HF of <<1 mg/m³ [N.tr. (dry standard conditions)] and of dust of <<1 mg/m³ [N.tr. (dry standard conditions)] and also a composition of CO₂ 1.4%, H₂O 10%, O₂ 4%, Ar 0.9% and a residual fraction of N₂.

1-26. (canceled)

27. A method for the separation of pollutants from a flue gas stream occurring during the firing of a fossil fuel in a combustion chamber of a power station, in a plurality of method stages, said method stages comprising:
a first method stage, in which the flue gas stream is subjected to gas scrubbing with a first chemical absorbent, and
a method stage that precedes the first method stage and in which the flue gas stream is subjected to flue gas desulfurization treatment by means of a calcium-containing chemical absorbent,
wherein, in the first method stage,
a flue gas scrub is carried out in at least one first absorber or flue gas scrubber by means of caustic soda or a sodium hydroxide-containing solution supplied as the first chemical absorbent to the flue gas stream,
at least part of the caustic soda or sodium hydroxide-containing solution being recirculated, preferably in a closed circuit, in this first method stage, outside the flue gas stream to the location of the supply of this chemical absorbent to the flue gas stream, and, in the course of its recirculation, being cooled outside the flue gas stream before it reaches the location of the supply to the flue gas stream and/or the flue gas stream being cooled inside the first absorber or flue gas scrubber by means of a cooler or heat exchanger arranged therein.

28. The method as claimed in claim 27, wherein, in the first method stage, the flue gas scrub is carried out in one or more spray scrubbers or jet scrubbers or Venturi scrubbers or in one or more packed towers.

29. The method as claimed in claim 27, wherein the flue gas stream supplied to the first method stage is divided, and, in the first method stage, a first part is supplied to a first spray scrubber or jet scrubber or Venturi scrubber or to a first packed tower and, in the first method stage, a second part is supplied in parallel to a third spray scrubber or jet scrubber or Venturi scrubber or to a third packed tower.

30. The method as claimed in claim 27, wherein the first chemical absorbent recirculated in the first method stage is cooled to a temperature of ≦40° C., preferably of ≦35° C.

31. The method as claimed in claim 27, wherein the flue gas stream or each of the part streams is cooled in the flue gas scrub of the first method stage to a temperature of ≦50° C., in particular of ≦45° C.

32. The method as claimed in claim 27, wherein the flue gas stream or the first and the second part of the flue gas stream is or are subjected, in a second method stage following the first method stage, to treatment with a second chemical absorbent different from that of the first method stage, in particular to an amine scrub, preferably a scrub with an alkanolamine solution, preferably monoethanolamine (MEA) solution, or to a potash scrub with potassium carbonate solution or to an ammonia scrub with an aqueous ammonia solution and/or with a solution containing at least two of the above solutions in mixture.

33. The method as claimed in claim 32, wherein a piperazine-containing second chemical absorbent is used.

34. The method as claimed in claim 32, wherein a regenerative second chemical absorbent is used, and this, after running through regeneration treatment in the second method stage, is recirculated into the flue gas stream or the first part and second part of the flue gas stream and is cooled before being supplied to the flue gas stream.

35. The method as claimed in claim 32, wherein, in the second method stage, the flue gas scrub is carried out in one or more spray scrubbers or jet scrubbers or Venturi scrubbers or one or more packed towers.

36. The method as claimed in claim 32, wherein the flue gas stream or flue gas part stream supplied to the second method stage is divided, and, in the second method stage, a third part is supplied to a second spray scrubber or jet scrubber or Venturi scrubber or to a second packed tower and, in the second method stage, a fourth part is supplied in parallel to a fourth spray scrubber or jet scrubber or Venturi scrubber or to a fourth packed tower.

37. The method as claimed in claim 27, wherein, in the method stage preceding the first method stage, the flue gas stream is subjected to a flue gas scrub by means of the calcium-containing chemical absorbent, gypsum thereby being formed.

38. The method as claimed in claim 27, wherein a water vapor-saturated flue gas stream is supplied to the flue gas scrub of the first method stage.

39. The method as claimed in claim 27, wherein part of the first chemical absorbent used in the first method stage is admixed to the chemical absorbent in the preceding method stage.

40. The method as claimed in claim 27, wherein the flue gas stream leaving the preceding method stage is supplied, preferably being divided into the first and the second part of the flue gas stream, directly to the first method stage.

41. The method as claimed in claim 27, wherein the flue gas stream leaving the first method stage is supplied, preferably being divided into the third or the fourth flue gas part stream, directly to the second method stage.

42. The method as claimed in claim 27, wherein all or part of the divided flue gas stream is or are subjected in each case to a dust-filtering treatment preceding at least the first or second or preceding method stage, preferably by means of an electrostatic filter.

43. The method as claimed in claim 27, wherein all or part of the divided flue gas stream are or is subjected in each case to a nitrogen oxide removal treatment preceding or following at least the first or second or preceding method stage, preferably by means of an, in particular catalytic, selective method.

44. The method as claimed in claim 27, wherein the method is carried out continuously, particularly with the first, second and preceding method stages being operated simultaneously.

45. A device for the separation of pollutants from a flue gas stream occurring during the firing of a fossil fuel in a combustion chamber of a power station, in a plurality of method stages which comprise a first method stage, which has a first absorber or flue gas scrubber with the supply of a first chemical absorbent, and a method stage which precedes the first method stage and which has a flue gas desulfurization plant with a calcium-containing chemical absorbent, wherein in the first absorber or flue gas scrubber, a spraying or atomizing device is arranged in the flue gas stream and supplies caustic soda or a sodium hydroxide-containing solution as the first absorbent to the flue gas stream, and, outside the first absorber or flue gas scrubber, a line is arranged which is line-connected to the inner space of the first absorber or flue gas scrubber, in such a way that at least part of the first absorbent can thereby be recirculated, preferably in a closed circuit, to the spraying or atomizing device, a cooler or heat exchanger being arranged, upstream of the spraying or atomizing device in the direction of flow of the recirculated first absorbent or of the flue gas stream, in the line and/or in the first absorber or flue gas scrubber in the flue gas stream.

46. The device as claimed in claim 45, wherein a cooler or heat exchanger is arranged in the line.

47. The device as claimed in claim 45, wherein the device has two first absorbers or flue gas scrubbers connected in parallel.

48. The device as claimed in claim 45, wherein the first absorber or first absorbers is or are designed as a spray scrubber or jet scrubber or Venturi scrubber or as a packed tower.

49. The device as claimed in claim 45, wherein the device has at least one second absorber or flue gas scrubber which follows the first absorber or flue gas scrubber and has means for flue gas scrubbing and in which a second absorbent different from the first absorbent, in particular an alkanolamine solution, in particular a monoethanolamine (MEA) solution, or a potassium carbonate solution or an aqueous ammonia solution can be supplied to the flue gas stream.

50. The device as claimed in claim 49, wherein the second absorber or flue gas scrubber is assigned an absorbent regeneration unit.

51. The device as claimed in claim 45, wherein the device comprises a dust filter and/or a nitrogen oxide removal device.
